(19) United States
(12) Patent Application Publication
(10) Pub. No.: US 2007/0279008 A1
(43) Pub. Date: Dec. 6, 2007

(54) Power Supply Apparatus

(76) Inventor: Osamu Miura, Odawara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/597,911

(22) PCT Filed: Jun. 1, 2005
(86) PCT No.: PCT/JP05/10032

§ 371 Date: Jul. 12, 2007

(30) Foreign Application Priority Data
Jun. 4, 2004 (JP) 2004-167026

(51) Int. Cl. H02J 7/00

(52) U.S. Cl. 320/166

(57) ABSTRACT

The engine startup performance and stability of the power supply voltage in activation of loads is concurrently ensured in a battery-less power supply apparatus.

The power generated in an AC generator 11 is supplied to a power supply line L via a regulator 12. The power supply line L is parallel-connected to a fuel injection system (FI load) 13 and first capacitor 14, and further parallel-connected to DC loads 15 and second capacitor 16 via a switch 17. After the first capacitor 14 is charged, the second capacitor 16 is charged by ON/OFF of the switch 17. When a plurality of loads contained in the DC loads 15 is simultaneously activated, the second capacitor 16 additionally supplies the power to each of the DC loads 15 to prevent the voltage of the power supply line L from decreasing.

### TECHNICAL FIELD

The present invention relates to a power supply apparatus of an engine electrical system without using a battery, and more particularly, to a power supply apparatus of a two-wheeled motor vehicle using a generator.

### BACKGROUND ART

In a battery-less fuel injection system without a battery, for example, a configuration provided with a capacitor is known to drive an injector (see Patent Document 1). Further, another configuration is known where in starting an engine of a two-wheeled motor vehicle or the like, electrical loads such as DC loads and the like are disconnected from a power supply line, thereby reducing the electrical loads in startup and improving engine startup characteristics (see Patent Document 2).

Patent Document 1: JP 2002-98032

Patent Document 2: JP H09-324732

### DISCLOSURE OF INVENTION

### Problems to be Solved by the Invention

However, in the above-mentioned configuration, when the capacitance of a capacitor is small, even after startup of the engine, when a plurality of electrical loads (DC loads and the like such as direction indicators, stop lamps, horn and the like) is activated simultaneously, the power supply voltage remarkably decreases, and it sometimes occurs that the operation of the fuel injection system halts and that the engine stalls. Meanwhile, when the capacitance of a capacitor is increased, much of the generated power in kick starting is absorbed by the capacitor, the time is required for the voltage to increase, and a problem arises that the engine startup performance degrades.

It is an object of the invention to concurrently ensure the engine startup performance and stability of the power supply voltage when loads are activated.

### Means for Solving the Problem

A power supply apparatus of the invention has a first capacitor that is connected to a power supply line which supplies power to a fuel injection system and that suppresses fluctuations in voltage of the power supply line, DC loads except the fuel injection system, and a second capacitor that is parallel-connected to the DC loads to exclusively supply the power to the DC loads.

For example, the second capacitor is charged by first switch means for passing a current through the power supply line and the second capacitor, after a predetermined time has elapsed since an engine is started. Alternately, for example, the second capacitor is charged by charging control means for controlling charging of the second capacitor when or after the engine is started.

Further, the charging control means preferably has power supply suppressing means for suppressing a power supply amount per unit time to the second capacitor. At this point, the power supply suppressing means suppresses the power supply amount, for example, using a resistance. Alternately, for example, the power supply suppressing means has second switch means, and the second switch means repeats charging of the second capacitor intermittently, and thereby reduces an average of the power supply amount per unit time.

To make the voltage of the power supply voltage more stable, first check means is preferably provided for preventing the power from being supplied from the first capacitor to the second capacitor and the DC loads. Further, for example, the power supply apparatus has second check means for preventing the power from being supplied from the second capacitor to the power supply line.

### Advantageous Effect of the Invention

As described above, according to the invention, in a battery-less power supply apparatus, it is possible to concurrently ensure the engine startup performance and stability of the power supply voltage when loads are activated.

### BEST MODE FOR CARRYING OUT THE INVENTION

Embodiments of the present invention will specifically be described below with reference to accompanying drawings.

FIG. 1 is a block diagram schematically illustrating an electrical configuration of a power supply system in a battery-less two-wheeled motor vehicle that is a first embodiment of the invention.

A power supply apparatus 10 of a two-wheeled motor vehicle of this embodiment is generally comprised of, for example, an AC generator (ACG) 11, regulator (Reg) 12, fuel injection system (FI load) 13, first capacitor 14, DC loads 15 comprised of direction indicators, stop lamps, horn and the like, second capacitor 16, and switch 17 (first switch means).

A power supply line L supplies the power from the AC generator 11 to each electrical system via the regulator 12. The power supply line L is parallel-connected to the FI load 13, first capacitor 14, DC loads 15, and second capacitor 16. The DC loads 15 and second capacitor 16 are parallel-connected to the power supply line L via the switch 17.

In kick starting, the switch 17 is OFF, and the power is not supplied to the DC loads 15 and second capacitor 16. In other words, in kick starting, the power generated by the AC generator 11 is only supplied to the first capacitor 14 and FI load 13. The capacitance of the first capacitor is small to the extent of not preventing startup of the FI load 13 caused by charging the first capacitor 14 in kick starting, while being large at least to the extent sufficient for continuous driving of the FI load 13 alone.

After the engine is started, when the switch 17 is turned ON while maintaining OFF of each apparatus included in the DC loads 15, charging of the second capacitor 16 is started. When a plurality of DC loads 15 is simultaneously turned ON, the second capacitor 16 supplies the power to the DC loads 15 and suppresses reduction in voltage of the power supply line L. In other words, when a plurality of DC loads 15 is simultaneously turned ON, the second capacitor 16 works to prevent the occurrence of an event that the FI load 13 halts and the engine stalls.

As described above, according to the power supply apparatus of the first embodiment, in addition to the first capacitor provided in the power supply of the fuel injection system, the dedicated second capacitor is provided for electrical loads except the fuel injection system, and charging of the second capacitor is shifted in time from charging of the first capacitor using the switch or the like. By this means, the electrical capacitance is increased in the entire power supply apparatus, while fluctuations in the power supply voltage are suppressed which would be caused by simultaneous activation of the electrical loads. At the same time, the power consumed by charging the capacitor is reduced in kick staring, and the startup performance is improved.

A power supply apparatus of a second embodiment of the invention will be described below with reference to FIG. 2. FIG. 2 is a block diagram schematically illustrating an electrical configuration of a power supply system in a battery-less two-wheeled motor vehicle that is the second embodiment. In addition, in the second embodiment, the same components as in the first embodiment are assigned the same reference numerals to omit descriptions thereof.

In a power supply apparatus 20 of the second embodiment, in addition to the configuration of the first embodiment, the second capacitor 16 is connected to the power supply line L via a resistance 18. In other words, in the second embodiment, irrespective of ON/OFF of the switch 17, the second capacitor 16 is supplied with slight power from the power supply line L via the resistance 18 and charged. In other words, the second capacitor 16 is charged more slowly over a longer period than the first capacitor 14. Accordingly, it does not occur that the voltage of the power supply line L decreases due to charging of the second capacitor 16, and that the power supply to the FI load 13 becomes insufficient.

Meanwhile, when a plurality of electrical devices of the DC loads 15 is simultaneously activated, as in the first embodiment, the power is supplied from the second capacitor 16, and the power supply voltage is prevented from decreasing.

As described above, substantially the same effects as in the first embodiment are obtained also in the second embodiment.

FIG. 3 is a block diagram schematically illustrating an electrical configuration of a power supply system in a battery-less two-wheeled motor vehicle that is the third embodiment. The same components as in the first and second embodiment are assigned the same reference numerals to omit descriptions thereof.

In a power supply apparatus 30 of the third embodiment, power supply to the second capacitor 16 of the first embodiment is controlled by a switching circuit 19 (second switch means). For example, the ground side of the second capacitor 16 is controlled to be ON/OFF by the switching circuit 19. The switching circuit 19 is connected to an electronic control unit not shown, and for example, controlled with pulse by the electronic control unit. Charging of the second capacitor 16 is repeated intermittently by actuating the switch circuit 19 after the switch 17 is turned ON.

In other words, in the second embodiment, charging of the second capacitor 16 is suppressed by connecting the resistance, and the power consumed by charging the second capacitor is kept low. In contrast thereto, in the third embodiment, the power is supplied to the second capacitor 16 intermittently using the switching circuit 19, the charge time is thereby made longer to keep an average of the power supply amount to the second capacitor 16 low, and the power supply voltage is prevented from remarkably decreasing due to charging of the second capacitor.

As described above, substantially the same effects as in the first and second embodiments are obtained also in the third embodiment.

FIG. 4 is a block diagram schematically illustrating an electrical configuration of a power supply system in a battery-less two-wheeled motor vehicle that is a fourth embodiment. The same components as in the first embodiment are assigned the same reference numerals to omit descriptions thereof.

In a power supply apparatus 40 of the fourth embodiment, a diode 21 is provided at some midpoint on the power supply line L from the regulator 12, and the diode 21 is connected at its cathode side to parallel-connected DC loads 15 and second capacitor 16 via the switch 17, while being connected at its anode side to parallel-connected first capacitor 14 and FI load 13. In other words, the electrical configuration of the fourth embodiment is the same as in the first embodiment except the diode 12 being provided.

In the first embodiment, when the switch 17 is turned ON after startup of the engine, the power stored in the first capacitor 14 is consumed by the DC loads 15 and charging of the second capacitor 16. According to the fourth embodiment, since the diode 21 is provided between the first capacitor 14, and the DC loads 15 and second capacitor 16, it is possible to prevent the power stored in the first capacitor 14 from being consumed by the DC loads 15 and second capacitor 16.

As described above, according to the fourth embodiment, in addition to the effects of the first embodiment, it is possible to prevent the power stored in the first capacitor from being consumed by the second capacitor and the loads other than the fuel injection system. It is thus possible to supply the power more stably to the fuel injection system, and further reduce the possibility of the fuel injection system going down.

FIG. 5 is a block diagram schematically illustrating an electrical configuration of a power supply system in a battery-less two-wheeled motor vehicle that is a fifth embodiment. The same components as in the first embodiment are assigned the same reference numerals to omit descriptions thereof.

In a power supply apparatus 50 of the fifth embodiment, the DC loads 15 and second capacitor 16 are parallel-connected to the power supply line L1 connecting the AC generator 11 and regulator 12 via the diode 22 and switch 17, and the diode 22 is connected at its cathode side to the power supply line L1, while being connected at its anode side to the DC loads 15 and second capacitor 16. Meanwhile, the power supply line L2 downstream from the regulator 12 is connected to the first capacitor 14 and FI load 13.

In the power supply apparatus 50 of the fifth embodiment, the power stored in the first capacitor 14 is consumed by only the FI load 13 by the existence of the regulator 12, while the power stored in the second capacitor 16 is consumed by only the DC loads 15 by the existence of the diode 22.

As described above, according to the fifth embodiment, it is possible to obtain substantially the same effects as in the fourth embodiment.

In addition, the present invention is effective even in a three-phase AC generator and full-wave rectification, and particularly, the effects of the invention are remarkable in a single-phase half-wave AC generator apt to cause large fluctuations in the power supply voltage. Further, the second embodiment and third embodiment are capable of being combined with the fourth embodiment and/or the fifth embodiment.

### BRIEF DESCRIPTION OF DRAWINGS

FIG. 1 is a block diagram schematically illustrating a configuration of a power supply apparatus of a two-wheeled motor vehicle that is the first embodiment of the invention;

FIG. 2 is a block diagram schematically illustrating a configuration of a power supply apparatus of a two-wheeled motor vehicle that is the second embodiment of the invention;

FIG. 3 is a block diagram schematically illustrating a configuration of a power supply apparatus of a two-wheeled motor vehicle that is the third embodiment of the invention;

FIG. 4 is a block diagram schematically illustrating a configuration of a power supply apparatus of a two-wheeled motor vehicle that is the fourth embodiment of the invention; and

FIG. 5 is a block diagram schematically illustrating a configuration of a power supply apparatus of a two-wheeled motor vehicle that is the fifth embodiment of the invention.

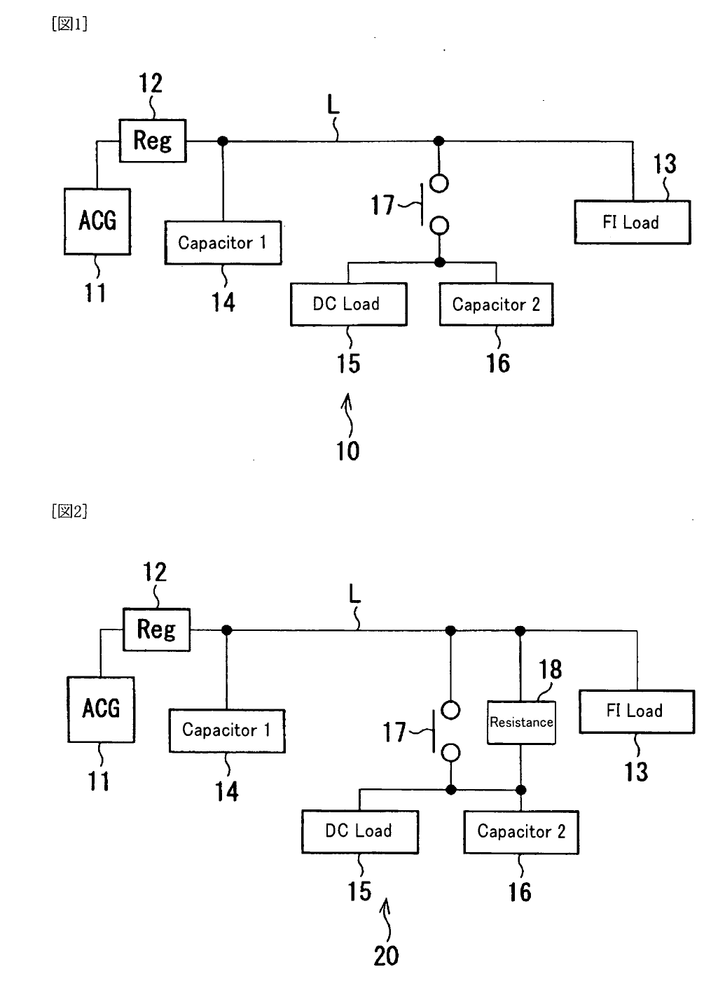

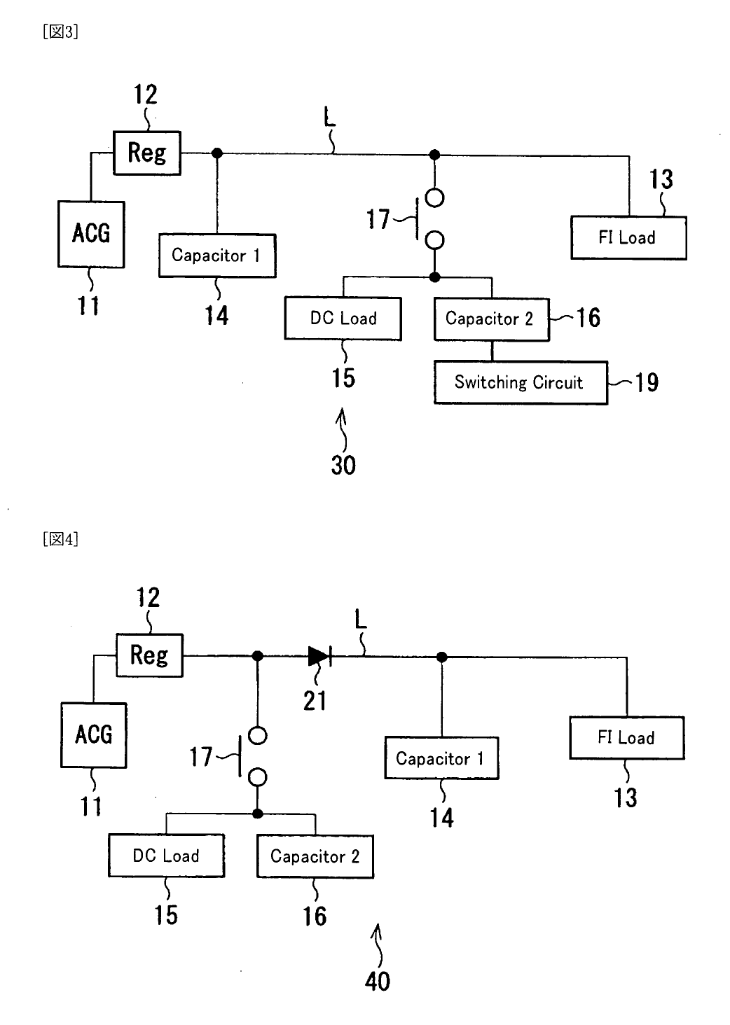

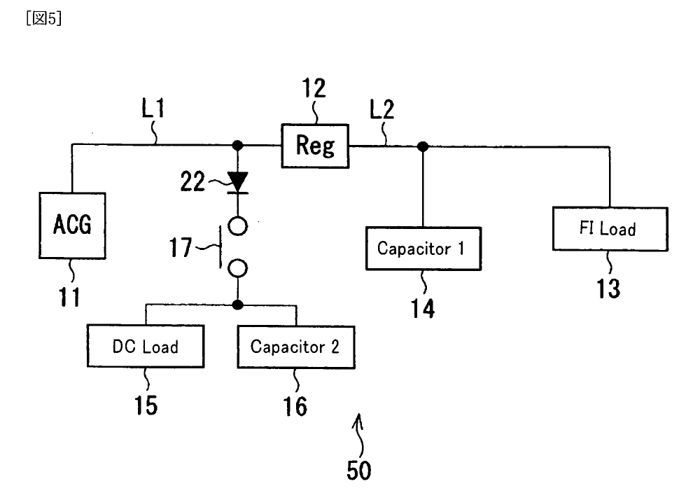

### BRIEF DESCRIPTION OF SYMBOLS

10 Power Supply Apparatus
11 AC Generator (ACG)
12 Regulator
13 Fuel Injection System (FI load)
14 First Capacitor (Capacitor 1)
15 DC Load
16 Second Capacitor (Capacitor 2)
L Power Supply Line

1. A power supply apparatus comprising:
a first capacitor that is connected to a power supply line which supplies power to a fuel injection system and that suppresses fluctuations in voltage of the power supply line;
DC loads except the fuel injection system; and
a second capacitor that is parallel-connected to the DC loads to exclusively supply the power to the DC loads.

2. The power supply apparatus according to claim 1, wherein the second capacitor is charged by first switch means for passing a current through the power supply line and the second capacitor, after a predetermined time has elapsed since an engine is started.

3. The power supply apparatus according to claim 1, wherein the second capacitor is charged by charging control means for controlling charging of the second capacitor when or after an engine is started.

4. The power supply apparatus according to claim 3, wherein the charging control means has power supply suppressing means for suppressing a power supply amount per unit time to the second capacitor.

5. The power supply apparatus according to claim 4, wherein the power supply suppressing means uses a resistance.

6. The power supply apparatus according to claim 4, wherein the power supply suppressing means has second switch means, and the second switch means repeats charging of the second capacitor intermittently, and thereby reduces an average of the power supply amount per unit time.

7. The power supply apparatus according to claim 1, further comprising:
first check means for preventing the power from being supplied from the first capacitor to the second capacitor and the DC loads.

8. The power supply apparatus according to claim 1, further comprising:
second check means for preventing the power from being supplied from the second capacitor to the power supply line.

9. The power supply apparatus according to claim 2, further comprising:
first check means for preventing the power from being supplied from the first capacitor to the second capacitor and the DC loads.

10. The power supply apparatus according to claim 3, further comprising:
first check means for preventing the power from being supplied from the first capacitor to the second capacitor and the DC loads.

11. The power supply apparatus according to claim 4, further comprising:
first check means for preventing the power from being supplied from the first capacitor to the second capacitor and the DC loads.

12. The power supply apparatus according to claim 5, further comprising:
first check means for preventing the power from being supplied from the first capacitor to the second capacitor and the DC loads.

13. The power supply apparatus according to claim 6, further comprising:
first check means for preventing the power from being supplied from the first capacitor to the second capacitor and the DC loads.

14. The power supply apparatus according to claim 2, further comprising:
second check means for preventing the power from being supplied from the second capacitor to the power supply line.

15. The power supply apparatus according to claim 3, further comprising:
second check means for preventing the power from being supplied from the second capacitor to the power supply line.

16. The power supply apparatus according to claim 4, further comprising:
second check means for preventing the power from being supplied from the second capacitor to the power supply line.

17. The power supply apparatus according to claim 5, further comprising:
second check means for preventing the power from being supplied from the second capacitor to the power supply line.

18. The power supply apparatus according to claim 6, further comprising:
second check means for preventing the power from being supplied from the second capacitor to the power supply line.

19. The power supply apparatus according to claim 7, further comprising:
second check means for preventing the power from being supplied from the second capacitor to the power supply line.

20. The power supply apparatus according to claim 9, further comprising:
second check means for preventing the power from being supplied from the second capacitor to the power supply line.
